(19) United States
(12) Patent Application Publication
(10) Pub. No.: US 2007/0071017 A1
(43) Pub. Date: Mar. 29, 2007

(54) Mechanism for automatically detecting, creating and configuring virtual LANs

(76) Inventor: Sushrut J. Mair, Bangalore (IN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/239,730

(22) Filed: Sep. 29, 2005

(51) Int. Cl. H04L 12/56

(52) U.S. Cl. 370/401; 370/389

(57) ABSTRACT

According to one embodiment, a virtual local area network (VLAN) detector is disclosed. The VLAN detector includes a reporter that stores VLAN IDs in a file, and an interface that is coupled to the reporter to check the file for information for creating a new VLAN and to transmit the information to a VLAN creator to create the new VLAN.

### FIELD OF THE INVENTION

The present invention relates to virtual local area networks (VLANs); more particularly, the present invention relates to the automated detection, creation and configuration of VLANs.

### BACKGROUND

VLANs are becoming more prevalent as traffic and the need for security on networks continue to increase. While, local area networks (LANs) group computers based on their location, VLANs group computers primarily based on traffic patterns, as well as common levels of security access. By grouping computers based on traffic patterns into VLANs, data is restricted to the computers that are to access to the data, effectively reducing network traffic and security risks.

Currently VLAN detection, creation and configuration are all done manually by a network administrator. Manual creating and configuration increases personnel and time costs.

### BRIEF DESCRIPTION OF THE DRAWINGS

The invention is illustrated by way of example and not limitation in the figures of the accompanying drawings, in which like references indicate similar elements, and in which:

FIG. 1 illustrates one embodiment of a network;

FIG. 2 illustrates one embodiment of a computer system;

FIG. 3 illustrates one embodiment of a virtual local area network (VLAN) detector; and

FIG. 4 illustrates one embodiment of a flow diagram of auto-detecting VLANs.

### DETAILED DESCRIPTION

A mechanism for automatically detecting, creating and configuring VLANs is described. In a further embodiment, a mechanism for automatically detecting link partner support for VLANs is described. In the following detailed description of the present invention numerous specific details are set forth in order to provide a thorough understanding of the present invention. However, it will be apparent to one skilled in the art that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

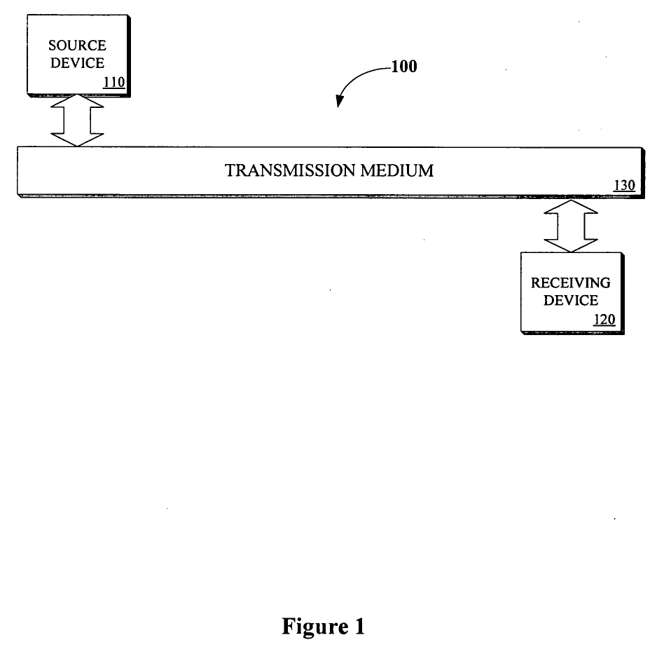

FIG. 1 illustrates one embodiment of a network 100. Network 100 includes a computer system 110 and a computer system 120 coupled via a transmission medium 130. In one embodiment, computer system 110 operates as a source device that sends an object to computer system 120, operating as a receiving device. The object may be, for example, a data file, an executable, or other digital objects. The object is sent via data transmission medium 130.

The data transmission medium 130 may be one of many mediums such as an internal network connection, an Internet connection, or other connections. The transmission medium 130 may be connected to a plurality of un-trusted routers (not shown) and switches (not shown) that may include the integrity of the object that is transmitted.

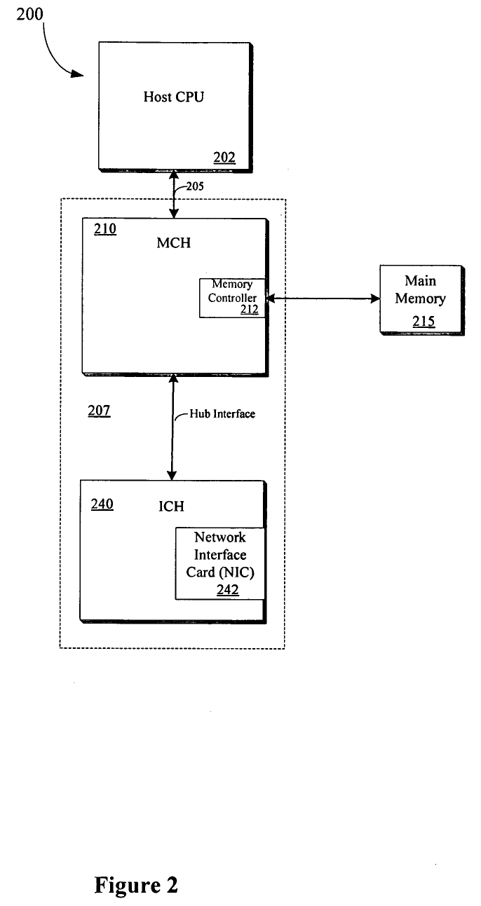

FIG. 2 is a block diagram of one embodiment of a computer system 200. Computer system 200 may be implemented at computer 110 or computer system 120, described above. Computer system 200 includes a central processing unit (CPU) 202 coupled to an interface 205. In one embodiment, CPU 202 is a processor in the Pentium® family of processors Pentium® IV processors available from Intel Corporation of Santa Clara, Calif. Alternatively, other CPUs may be used. For instance, CPU 202 may be implemented using multiple processing cores. In other embodiments, computer system 200 may include multiple CPUs 202

In a further embodiment, a chipset 207 is also coupled to interface 205. Chipset 207 includes a memory control hub (MCH) 210. MCH 210 may include a memory controller 212 that is coupled to a main system memory 215. Main system memory 215 stores data and sequences of instructions that are executed by CPU 202 or any other device included in system 200. In one embodiment, main system memory 215 includes dynamic random access memory (DRAM); however, main system memory 215 may be implemented using other memory types. Additional devices may also be coupled to interface 205, such as multiple CPUs and/or multiple system memories.

MCH 210 is coupled to an input/output control hub (ICH) 240 via a hub interface. ICH 240 provides an interface to input/output (I/O) devices within computer system 200. ICH 240 may support standard I/O operations on I/O busses such as peripheral component interconnect (PCI), accelerated graphics port (AGP), universal serial bus (USB), low pin count (LPC) bus, or any other kind of I/O bus (not shown).

According to one embodiment, ICH 240 includes a network interface card (NIC) 242. NIC 242 serves as an interface for network traffic between computer system 200 and other devices. In a further embodiment, NIC 242 includes a virtual local area network (VLAN) detector.

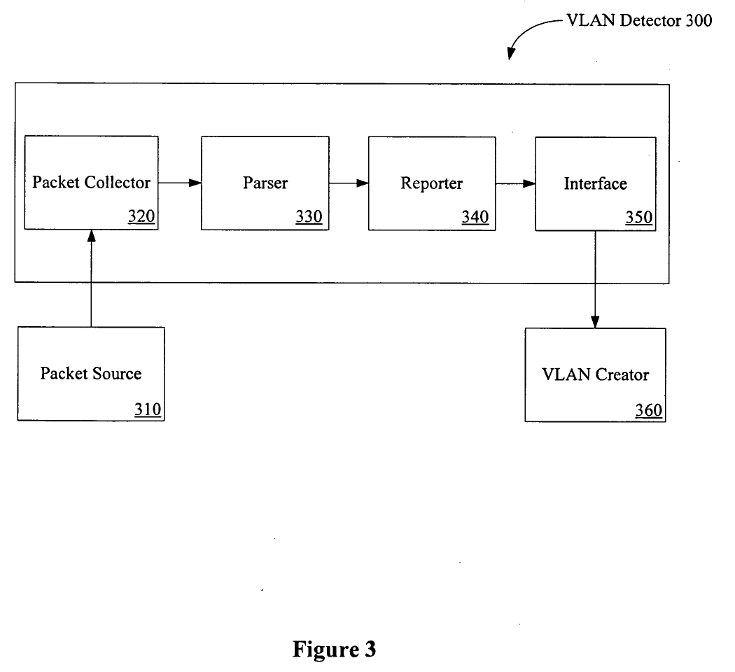

FIG. 3 illustrates one embodiment of a VLAN detector 300. VLAN detector 300 is coupled to a packet source 310 and a VLAN creator 360. VLAN creator 360 is an application that receives data from VLAN detector 300 and creates a VLAN.

VLAN detector 300 includes a packet collector 320, a parser 330, a reporter 340 and an interface 350. In one embodiment, packet source 310 is a packet collection application (e.g., Wincap™) for capturing packets on network 100. However, other applications may be used. In another embodiment, packet source 310 may be implemented within NIC 242, thus eliminating the need for a packet collection application.

Packet collector 320 collects packets from packet source 310. Packet collector 320 also checks for tagging information within the packet. In one embodiment, the tagging information is IEEE 802.1Q standard tagging. However, in an alternative embodiment, other tagging may be checked for. Packet collector 320 also checks for link partner format information which can detail support for VLAN creation.

In one embodiment, the link partner format information is a Cisco Discovery Protocol (CDP), by Cisco Systems™ of Irvine, Calif. However, in another embodiment, other link partner format information can be checked for. Packet collector 320 forwards packets that include tagging or link partner format information to parser 330, and drops all other packets.

Parser 330 accepts the packets from packet collector 320. In one embodiment, parser 330 examines the packets and classifies the packets as either a tagged packet or a link partner packet. For the tagged packets, parser 330 parses out and stores the VLAN IDs contained in the packets. For the link partner packets, parser 330 is sub-divided into sub-parsers that correspond to each individual link partner. The VLAN IDs are still parsed out and stored. In addition, link partner format information is parsed out and stored.

Reporter 340 receives the VLAN IDs and the link partner format information from parser 330 and stores them to a file. In one embodiment, reporter 340 segregates the received information into VLAN IDs and link partner format information. The link partner format information displays what type of VLANs the link partner supports.

Interface 350 checks the file maintained by reporter 340 to determine if the file contains information for creating a new VLAN. If such information is found, interface 350 sends the information to VLAN creator 360 to create the new VLAN.

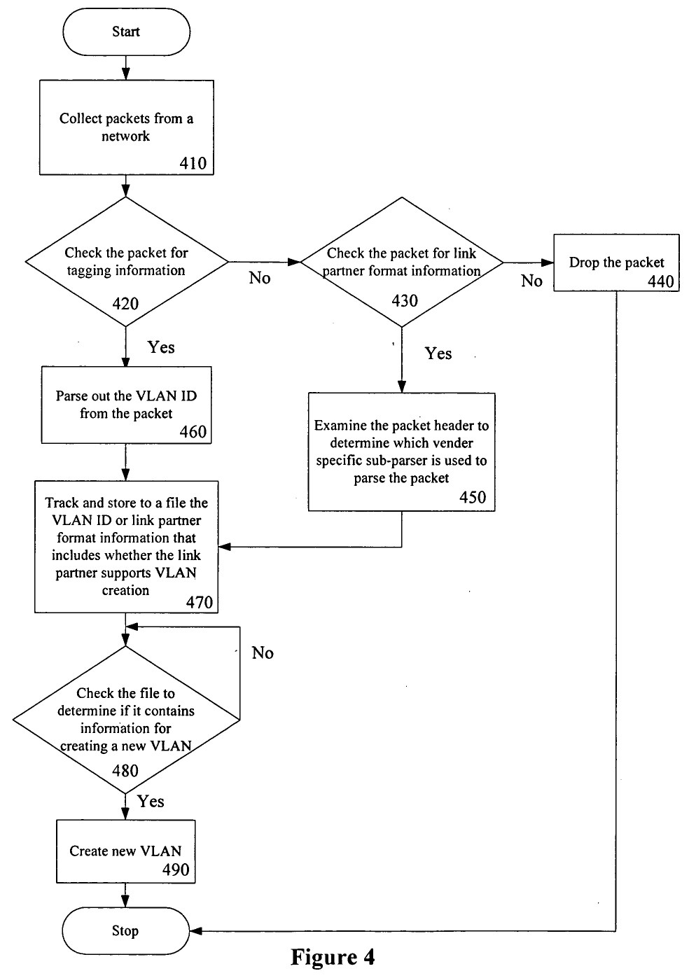

FIG. 4 is a flow diagram illustrating one embodiment of the operation of VLAN detector 300. At processing block 410, packets are collected from a network (e.g., network 100). At decision block 420, the collected packets are checked to determine whether they include tagging information. If tagging information is found, the VLAN ID of the packet is parsed out, processing block 460. Otherwise, the packets are checked to determine whether they include link partner format information, decision block 430.

If the packet includes link partner format information, the packet header is examined to determine which corresponding link partner sub-parser is to be used to parse out the VLAN ID and link partner format information from the packet, processing block 450. Otherwise, the packet is dropped, processing block 440.

At processing block 470, the VLAN IDs and link partner format information is tracked and stored to a file. At decision block 480, the file is checked to determine if it includes information for creating a new VLAN. The file continues to be checked until information for creating a new VLAN is found. The new VLAN is then created, processing block 490.

The above-described process automatically detects existing VLANs, and creates and configures new VLANs on a network. Thus, providing a more efficient way to manage VLANs, as well as reducing the costs associated with VLAN management.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A virtual local area network (VLAN) detector comprising:
a reporter to store VLAN IDs in a file; and
an interface coupled to the reporter to check the file for information for creating a new VLAN and to transmit the information to a VLAN creator to create the new VLAN.

2. The VLAN detector of claim 1 further comprising:
a packet collector to collect packets from a network and to check tagging information included within the packets; and
a parser coupled to the packet collector to parse out the VLAN IDs from the packets.

3. The VLAN detector of claim 2 wherein the parser parses out link partner information.

4. The VLAN detector of claim 3 wherein the parser is sub-divided into a plurality of sub-parsers corresponding to each link partner.

5. The VLAN detector of claim 1 wherein a packet source is coupled to the VLAN detector to capture packets from the network.

6. The VLAN detector of claim 5 wherein the packet source is included in a network interface card (NIC).

7. A method comprising:
parsing out virtual local area network (VLAN) IDs from packets on a network;
storing the VLAN IDs to a file;
checking the file for information for creating a new VLAN; and
creating the new VLAN.

8. The method of claim 7 further comprising:
collecting the packets on the network; and
checking the packets for tagging information.

9. The method of claim 8 further comprising checking the packets for link partner information.

10. The method of claim 9 further comprising dropping a packet if the packet does not contain one of the following: tagging information, and link partner information.

11. A machine-readable medium having stored thereon data representing sets of instructions which, when executed by a machine, cause the machine to:
parse out virtual local area network (VLAN) IDs from packets on a network;
store the VLAN IDs to a file;
check the file for information for creating a new VLAN; and
create the new VLAN.

12. The machine-readable medium of claim 11, wherein the sets of instructions when executed by the machine, further cause the machine to:
collect the packets on the network; and
check the packets for tagging information.

13. The machine-readable medium of claim 12 wherein the sets of instructions when executed by the machine, further cause the machine to check the packets for link partner information.

14. The machine-readable medium of claim 13 wherein the sets of instructions when executed by the machine, further cause the machine to drop a packet if the packet does not contain one of the following: tagging information, and link partner information.

15. A system comprising:
a first computer system;
a transmission medium coupled to the first computer system; and
a second computer system, coupled to the transmission medium, having a virtual local area network (VLAN) detector including:
a reporter to store VLAN IDs in a file; and
an interface coupled to the reporter to check the file for information for creating a new VLAN and to transmit the information to a VLAN creator to create the new VLAN.

16. The system of claim 15 wherein the VLAN detector further comprises:
a packet collector to collect packets from a network and to check tagging information included within the packets; and
a parser coupled to the packet collector to parse out the VLAN IDs from the packets.

17. The system of claim 16 wherein the parser parses out link partner information.

18. The system of claim 17 wherein the parser is sub-divided into a plurality of sub-parsers corresponding to each link partner.

19. The system of claim 15 further comprising a packet source coupled to the VLAN detector to capture packets from the network.

20. The system of claim 19 wherein the packet source is included in a network interface card (NIC).
